(19) United States
(12) Patent Application Publication
(10) Pub. No.: US 2010/0070706 A1
(43) Pub. Date: Mar. 18, 2010

(54) Method of Allocating Physical Volume Area to Virtualized Volume, and Storage Device

(75) Inventor: Hirofumi Inomata, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/266,843

(22) Filed: Nov. 7, 2008

(30) Foreign Application Priority Data
Sep. 17, 2008 (JP) 2008-237327

(51) Int. Cl. G06F 12/00; G06F 12/02

(52) U.S. Cl. 711/114; 711/170; 711/E12.001; 711/E12.002

(57) ABSTRACT

In a storage device in which physical memory areas are sequentially allocated to virtual volumes according to an access, data are divided based on data creation date and so and are stored in physical RGs. The storage device includes a memory unit including a plurality of physical RGs including a first physical RG; and a controller. The controller sequentially allocates a memory area of the first physical RG or a pool memory area including a plurality of first physical RGs to a first virtual volume based on a use order according to an access to the first virtual volume, receives a break request, and allocates the memory area of the first physical RG of the next use order or the pool memory area including the plurality of first physical RGs of the next use order to the first virtual volume according to the access to the first virtual volume after receiving the break request.

### CROSS REFERENCES TO RELATED APPLICATIONS

This application relates to and claims priority from Japanese Patent Application No. 2008-237327, filed on Sep. 17, 2008, the entire disclosure of which is incorporated herein by reference.

### BACKGROUND OF THE INVENTION

1. Field of the Invention

The present invention relates to a storage system having capacity virtualization function, and more particularly, to a method of allocating a physical volume area to a virtualized volume.

2. Description of the Related Art

In general, in a database management system (DBMS), records are registered in sequence with a database table (DB table). In a disk volume of a storage device storing a database table, an area storing the database table is extended to meet with the storage of records. This extension of area is performed by a program contained in the DBMS or a database manager who uses management function of the DBMS. Since this extension of area is performed in sequence according to increase in capacity of the DB table, records having low access frequency and records having high access frequency are mixed together in a disk volume.

In addition, in general, as a main use of DBMS, there is a business system for Enterprise Resource Planning (ERP) In this use, whenever a transaction occurs, a record retaining contents of the transaction is added to the DB table and thus the capacity of the DB table increases with the lapse of time. In addition, the record access frequency tends to take the same characteristic every order of year when a record is added. For example, a record access mainly occurs at a year when a transaction occurs, and a record access thereafter tends to occur in an aggregating process which occurs over a span of the end of a month, the end of a term, the end of a year, or several years.

In a search from DBMS, when a record is to be accessed with limitation to a certain period of time, the record is searched with search conditions including, for example, an index column of a registered date and a term of the date. This is a typical method to prevent an unnecessary record from being searched.

Non-Patent Document 1 (described below) discloses an example of tuning performance of DBMS using a tool for reallocation of DB areas. When a plurality of disk volumes are used from the DBMS, some or all of memory areas of a DB table are reallocated so that an access from the DBMS is not concentrated on a particular disk volume.

Patent Document 1 (described below) discloses a technique for capacity virtualization of a disk volume in a storage system. In this technique, in order to improve use efficiency of memory capacity of a disk device, a virtual disk volume is provided to the outside (a host computer and so on), memory areas of a physical disk volume are allocated to the virtual disk volume in actuality whenever data are recorded, and the data are stored in the physical disk volume. At this time, the physical disk volume is allocated to one or more pool areas and the memory areas are allocated to the virtual disk volume in a predetermined order.

Patent Document 2 (described below) discloses a structure of power-saving in a RAID (Redundant Arrays of Inexpensive Disks) storage system. This spins down a parity disk from RG (RAID Group) including a plurality of disk devices on the basis of an RAID algorithm. When the RG from which the parity disk is spun down is write-accessed, write data are received in a write back mode and are temporarily held in a disk cache, and write access to the spun-down disk device is performed with a delay after spin-up. This method allows a spin-down of some disks of the plurality of disk devices constituting the RG.

[Patent Document 1] Japanese Patent Application Laid-Open No. 2007-316725

[Patent Document 2] U.S. Pat. No. 7,035,972B2

[Non-Patent Document 1] U.S. Oracle Corporation, “Oracle Database 11g Automatic Storage Management New Features Technical White Paper,” June, 2007, (http://www.oracle.com/technology/products/database/asm/pdf/11gr1%20asm%20new%20features%20wp%2005-2007.pdf)

### SUMMARY OF THE INVENTION

In recent years, with a high growth of physical integration of IT systems, there is a high demand to power-saving. With development of semiconductor technologies, reduction of power consumption has been slowly achieved with the times. In compliance with the reduction of power consumption, components of an IT system accomplish more-effective power saving by consuming power only while they are in use. Such power saving can not be accomplished only by artificial means, but a power saving structure based on the nature of an IT system is required to be equipped in the IT system.

An ERP system may be representative of an IT system. Most of ERP systems are business systems using DBMS. When DBMS is used for the ERP system, transactions occur frequently with the lapse of time and records retaining contents of the transactions are added to a DB table. The contents of the transactions are inquired and updated until the transactions are terminated. When the transactions are terminated, the DB table is maintained with the contents at the termination of the transactions. As records with the transactions terminated require for result aggregation and audit, a record access occurs. Accordingly, in the ERP system, a frequency of an access to an old record with a transaction terminated of the DB table has a tendency to be lower than a frequency of an access to a new record during transaction. When records are dividedly stored in disk volumes provided by year, it is possible to spin down disk volumes storing old data. However, on this account, it is not common to design a configuration of a DB table of DBMS based on the division of records. Although data can be moved between disk volumes using a tool for DB area reallocation of Non-Patent Document 1, it takes a long time to move the enormous amount of data.

In addition, virtual disk volumes provided to a host computer to which a volume capacity virtualization technique disclosed in Patent Document 1 is applied has no one-to-one correspondence with physical disk volumes (or RAID Groups). In addition, since a repository of a memory area is determined by a storage device, a correct memory area repository can not be known. Accordingly, even of the DB area reallocation tool of Non-Patent Document 1 is used, a record having the same access frequency can not be moved to the same physical disk volume. In addition, when a plurality of disk volumes is used to disperse an access to a particular disk volume, if the disk volumes are virtual volumes, even through the virtual volumes are disk volumes recognized by a host separately, sine their memory areas may be actually allocated to one physical disk volume, dispersion of access may not be achieved.

As apparent from the above description, in the conventional techniques, in a storage device having a capacity virtualization function for the purpose of efficient use of disk capacity in an ERP system, even when capacity virtualization disk volumes are provided by year, a physical repository of a record can not be stored in physical disk volumes different by year. That is, old and new records are stored in disk volumes of the physical unit which can be spun-down. Accordingly, there arises a problem of impossible creation of physical disk volumes which can be spun-down for power saving.

To overcome the above problem, according to an aspect of the invention, there is provided a storage device including: a memory unit including a plurality of physical RAID groups including a first physical RAID group; and a controller, the controller sequentially allocating a memory area of the first physical RAID group or a pool memory area including a plurality of first physical RAID groups to a first virtual volume based on a use order according to an access to the first virtual volume, receiving a break request, and allocating the memory area of the first physical RAID group of the next use order or the pool memory area including the plurality of first physical RAID groups of the next use order to the first virtual volume according to the access to the first virtual volume after receiving the break request.

According to another aspect of the invention, there is provided a method of allocating a memory area to a virtual volume of a storage device including a memory unit including a plurality of physical RAID groups including a first physical RAID group, and a controller, the method including the steps of: sequentially allocating a memory area of the first physical RAID group or a pool memory area including a plurality of first physical RAID groups to a first virtual volume based on a use order according to an access to the first virtual volume; receiving a break request; and allocating the memory area of the first physical RAID group of the next use order or the pool memory area including the plurality of first physical RAID groups of the next use order to the first virtual volume according to the access to the first virtual volume after receiving the break request.

### BRIEF DESCRIPTION OF THE DRAWINGS

FIG. 1 is a view showing a physical system configuration according to an embodiment of the present invention.

FIG. 2 is a view showing a physical storage configuration according to an embodiment of the present invention.

FIG. 3 is a view showing a logical storage configuration according to an embodiment of the present invention.

FIG. 4 is a view showing a DBMS server configuration according to an embodiment of the present invention.

FIG. 5 is a view showing a storage management server configuration according to an embodiment of the present invention.

FIG. 6 is a view showing a logical storage configuration (an example of addition of an extended DB area) according to an embodiment of the present invention.

FIG. 7 is a view showing allocation (normal) of a memory area to a virtual VOL according to an embodiment of the present invention.

FIG. 8 is a view showing allocation (when a break request is received) of a memory area to a virtual VOL according to an embodiment of the present invention.

FIG. 9 is a view showing allocation (after a break request is received) of a memory area to a virtual VOL according to an embodiment of the present invention.

FIG. 10 is a diagram showing a configuration of a table “Configuration Management” according to an embodiment of the present invention.

FIG. 11 is a diagram showing a configuration (variation) of a table “configuration management” according to an embodiment of the present invention.

FIG. 12 is a diagram showing a configuration of a table “used area management” according to an embodiment of the present invention.

FIG. 13 is a diagram showing a configuration of a table “free area management” according to an embodiment of the present invention.

FIG. 14 is a flow chart showing a flow of management system process according to an embodiment of the present invention.

FIG. 15 is a flow chart showing a flow of input/output system process according to an embodiment of the present invention.

FIG. 16 is a flow chart showing a flow of configuration management process according to an embodiment of the present invention.

FIG. 17 is a flow chart showing a flow of break request process according to an embodiment of the present invention.

FIG. 18 is a flow chart showing a flow (1) of input/output request process according to an embodiment of the present invention.

FIG. 19 is a flow chart showing a flow (2) of input/output request process according to an embodiment of the present invention.

FIG. 20 is a flowchart showing a flow (3) of input/output request process according to an embodiment of the present invention.

FIG. 21 is a flow chart showing a sequence of additional operations of an extended DB area according to an embodiment of the present invention.

FIG. 22 is a diagram showing an exemplary configuration of a DB table according to an embodiment of the present invention.

FIG. 23 is a view showing an example of SQL inquiry according to an embodiment of the present invention.

FIG. 24 is a view showing a physical system configuration (variation) according to an embodiment of the present invention.

FIG. 25 is a view showing a physical storage device configuration (variation) according to an embodiment of the present invention.

FIG. 26 is a view showing a logical storage configuration (variation) according to an embodiment of the present invention.

FIG. 27 is a view showing a host device configuration (variation) according to an embodiment of the present invention.

FIG. 28 is a flow chart showing a flow of DB area reallocation process according to an embodiment of the present invention.

FIG. 29 is a view showing an exemplary configuration of DB area reallocation according to an embodiment of the present invention.

### REFERENCE NUMERALS

10000: Database Management System (DBMS) server

20000: Storage device

30000: Storage management sever

40000: Storage Area Network (SAN)

50000: Management network

41001˜41002: Storage connection path

51001˜51003: Network connection path

### DETAILED DESCRIPTION OF PREFERRED EMBODIMENTS

Hereinafter, preferred embodiments of the present invention will be described in detail with reference to the drawings.

### (1) Embodiment 1

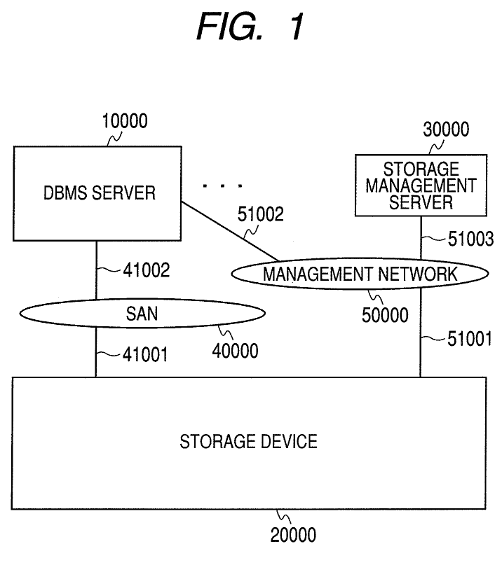

FIG. 1 shows an IT system configuration according to Embodiment 1. The IT system of this embodiment includes an DBMS server 10000, a storage device 20000, a storage management server 30000, a SAN (Storage Area Network) 40000, a management network 50000, and data paths 41001, 41002 and 51001 to 51003 which interconnect the above components, respectively.

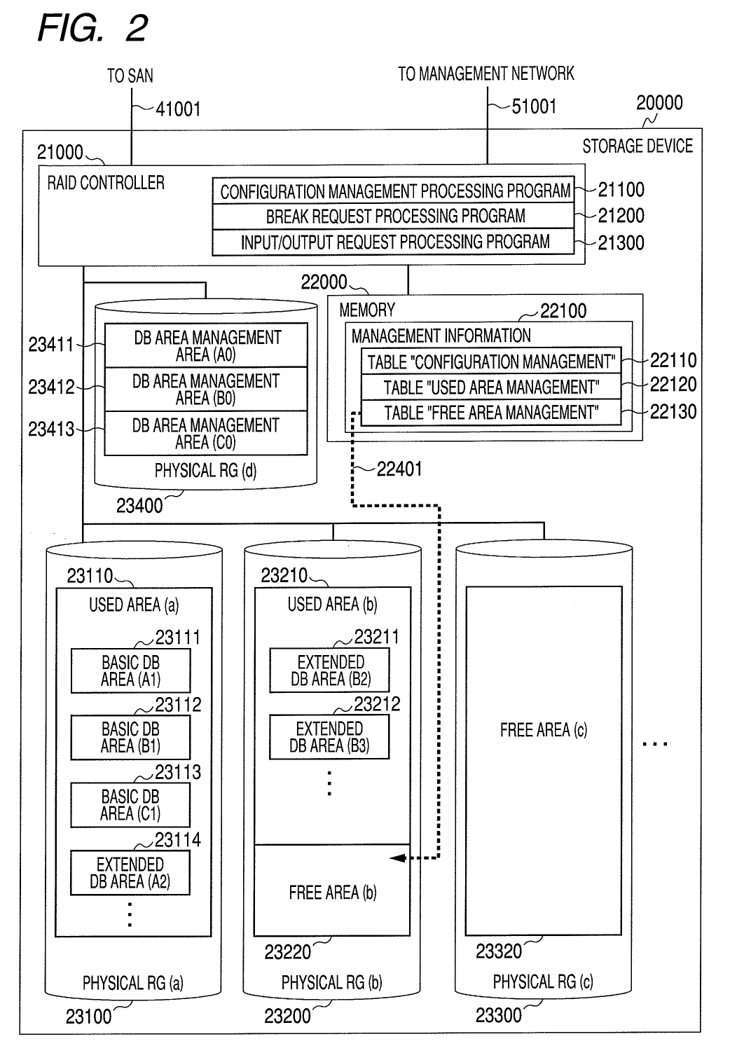

FIG. 2 shows a physical configuration of the storage device 20000. The storage device 20000 includes a RAID controller 21000, a memory 22000, a physical RG (RAID group) (a) 23100, a physical RG(b) 23200, a physical RG(c) 23300, and a physical RG(d) 23400. Here, a physical RG refers to a physical RAID group and the number of groups in FIG. 2 is not particularly limited but may be a plurality of groups. In case of a disk controller which employs no RAID, a physical disk volume may be applied for the physical RAID group.

The RAID controller 21000 retains a configuration management processing program 21100, a break request processing program 21200 and an input/output request processing program 21300. The RAID controller 21000 is connected to the SAN 40000 via the data path 41001 and is connected to the management network 50000 via the data path 51001. In addition, the RAID controller 21000 is connected to the memory 22000 and the physical RG(a) 23100 to physical RG(d) 23400 via one or more data paths.

The memory 22000 stores management information 22100. The management information 22100 includes a table “configuration management” 22110, a table “user area management” 22120 and a table “free area management” 22130.

In the following description, allocation of a memory area in a physical RG is provided only by way of an example for the purpose of simplification of description. Also, it is assumed that a DB manager first creates DB basic areas in three virtual volumes, respectively. Configurations of a physical RG and a virtual volume are not limited to those shown and described in the drawings and the description.

The physical RG(a) 23100 includes a user area(a) 23110. This example corresponds to a state where the physical RG(a) 23100 has no free area. The used area(a) 23110 includes a basic DB area(A1) 23111, a basic DB area(B1) 23112, a basic DB area(C1) 23113 and an extended DB area(A2) 23114.

The physical RG(b) 23200 includes a use area(b) 23210 and an free area(b) 23220. The used area(b) 23210 includes an extended DB area(B2) 23211 and an extended DB area (B3) 23212. Here, an free area refers to a memory area which has been not yet allocated to a virtual volume. Accordingly, the physical RG(b) corresponds to an example of a physical RG having still a unused area (non-allocated area). Typically, when memory areas are needed according to an access to a virtual VOL, the memory areas are sequentially allocated from a unused area of the physical RG(b). In this embodiment, an access includes a write access and a read access.

The physical RG(c) 23300 includes a free area(c) 23320. The physical RG(c) corresponds to an example of a new physical RG which has been not yet allocated to a virtual volume. In this example, in case where a free area of the physical RG(b) disappears, when memory areas are needed according to an access to a following virtual VOL, the memory areas are allocated from this physical RG(c).

The physical RG(d) 23400 includes a DB area management area (A0) 23411, a DB area management area (B0) 23412 and a DB area management area (C0) 23413. In this embodiment, in the physical RG(d) 23400, all memory areas are always allocated to a virtual VOL(d) without being sequentially allocated to a virtual volume according to an access or the like to use it. In this example, a DB area management area refers to an area storing information used for repository management of a DB area by DBMS. A DB manager configures DBMS so that information which is accessed uniformly or is expected to be accessed uniformly is stored in advance in a DB area management area, irrespective of whether information is new or old.

An arrow of a correspondence relation 22401 indicates a head of a free area held by the table “free area management” 22130. FIG. 2 shows a head of the free area(b). If new memory areas are required for a virtual volume, these memory areas are sequentially allocated from this free area(b) 23220.

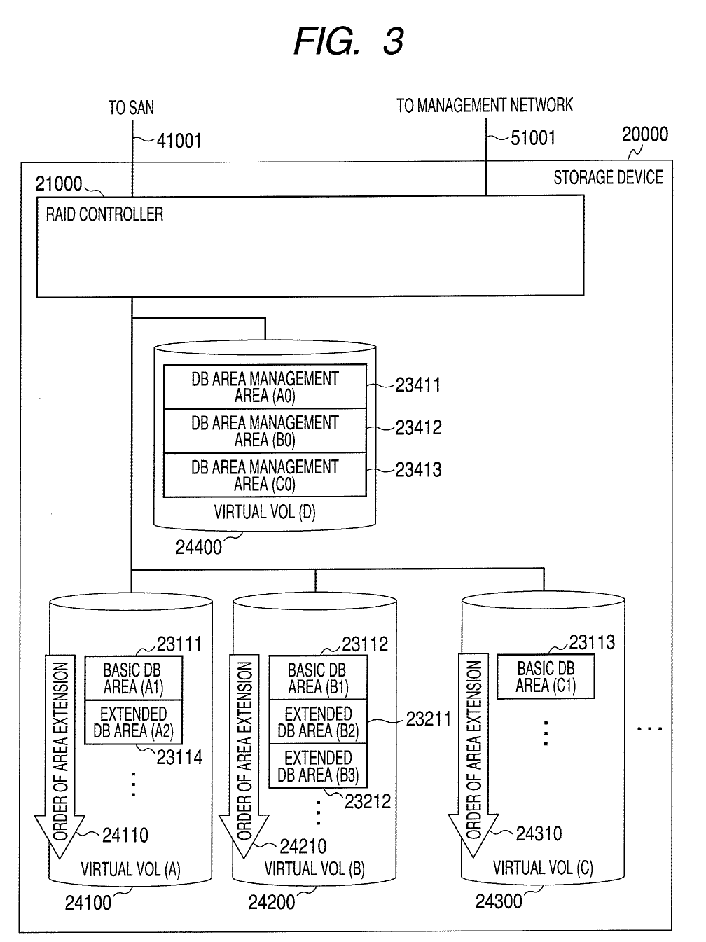

FIG. 3 shows a logical configuration of the physical configuration shown in FIG. 2. The RAID controller 21000 operates such that a virtual VOL (virtual volume) (A) 24100, a virtual VOL(B) 24200, a virtual VOL(C) 24300 and a virtual VOL(D) 24400 exist when viewed from the SAN 40000. Here, a virtual VOL means a virtual disk volume. Physical RGs are allocated as real memory areas of a virtual VOL, respectively. For example, the RAID controller 21000 causes the virtual VOL (A) 24100 to be appeared as a disk volume including the basic DB area (A1) 23111 and the extended DB area (A2) 23114. Likewise, the virtual VOL (B) 24200 includes the basic DB area (B1) 23112, the extended DB area(B2) 23211 and the extended DB area(B3) 23212. The virtual VOL(C) 24300 includes the basic DB area (C1) 23113. An arrow 24110, an arrow 24210 and an arrow 24310 indicate a temporal order at which DB areas are added. That is, this indicates new DB areas along leading ends of the arrows.

The virtual VOL (D) 24400 includes the DB area management area(A0) 23411, the DB area management area(B0) 23412 and the DB area management area (C0) 23413. In the virtual VOL (D), all memory areas of the physical RG(d) are allocated as memory areas of the virtual VOL(D) instead of allocating memory areas of the physical RG(b) from the physical RG(a) according to an access.

As described above, it can be seen from FIGS. 2 and 3 that, when a virtual volume is used, memory areas of different virtual volumes are not necessarily allocated to different physical volumes.

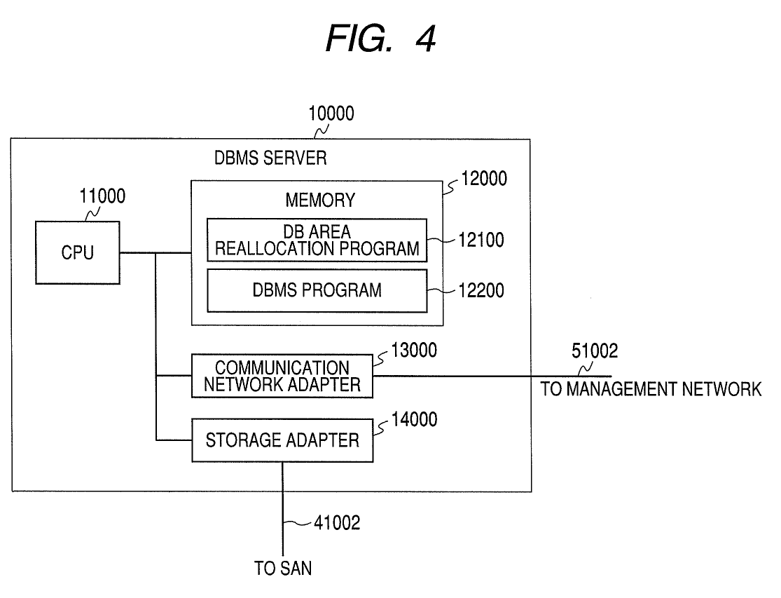

FIG. 4 shows a configuration of the DBMS server 10000. The DBMS server 10000 includes a CPU 11000, a memory 12000, a communication network adapter 13000 and a storage adapter 14000, which are interconnected via data paths, respectively.

The memory 12000 stores a DB area reallocation program 12100 and a DBMS program 12200. The DB area reallocation program 12100 is software of a conventional general database management system. The DBMS program 12200 also is software of a conventional general database management system.

The communication network adapter 13000 may be a general Nic supporting an IP protocol and is connected to the management network 50000 via the data path 51002. The storage adapter 14000 may be a general HostBus Adapter such as SCSI, Fiber Channel and the like and is connected to the SAN 40000 via the data path 41002.

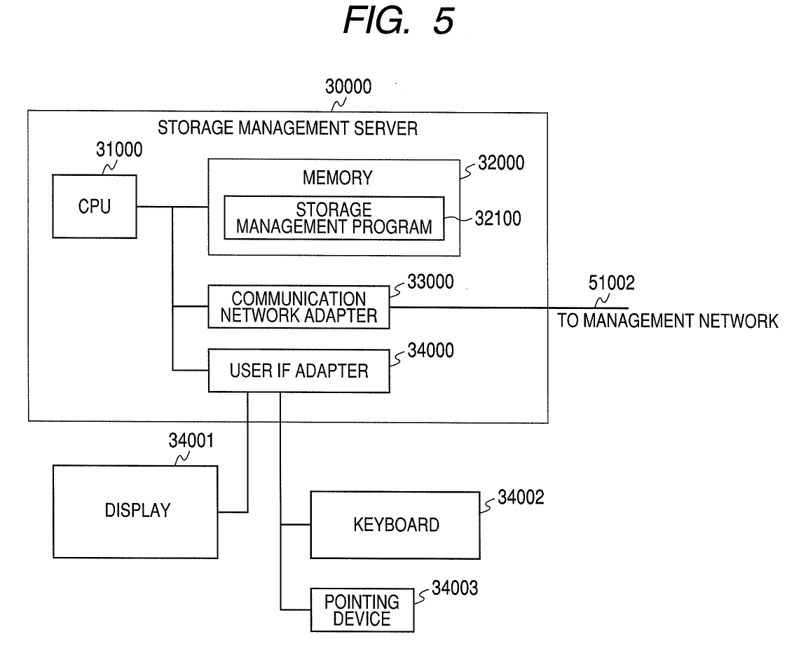

FIG. 5 shows a configuration of the storage management server 30000.

The storage management server 30000 includes a CPU 31000, a memory 32000, a communication network adapter 33000 and a user IF adapter 34000, which are interconnected via data paths, respectively. The memory 32000 stores a storage management program 32100. In this embodiment, the storage management program 32100 may be a program to cause an instruction from a user IF to be sent to the storage device 20000 via the management network 50000.

The communication network adapter 33000 may be a general Nic supporting an IP protocol and is connected to the management network 50000 via the data path 51002.

The user IF adapter 34000 is an interface adapter connecting a display 34001, as a device for showing information to an operator, to a keyboard 34002 and a pointing device 34003 as devices for inputting information. Examples of the pointing device 34003 may include a mouse, a track ball and so on.

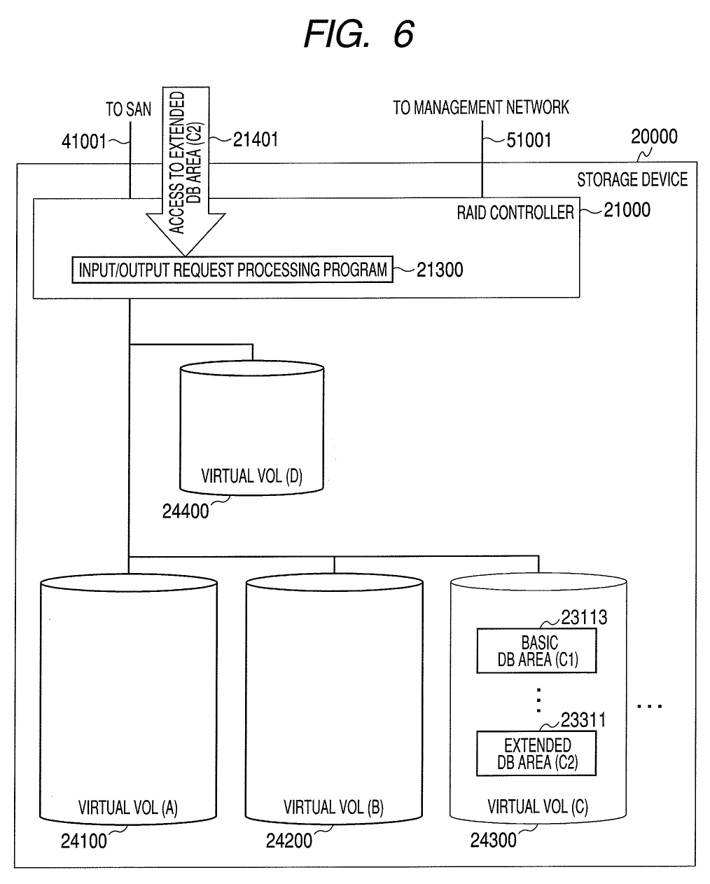

FIG. 6 shows a logical configuration of the storage device 20000 when there occurs an access 21401 to an extended DB area(C2) 23311 as a new memory area in the virtual VOL(C) 24300 as a virtual volume.

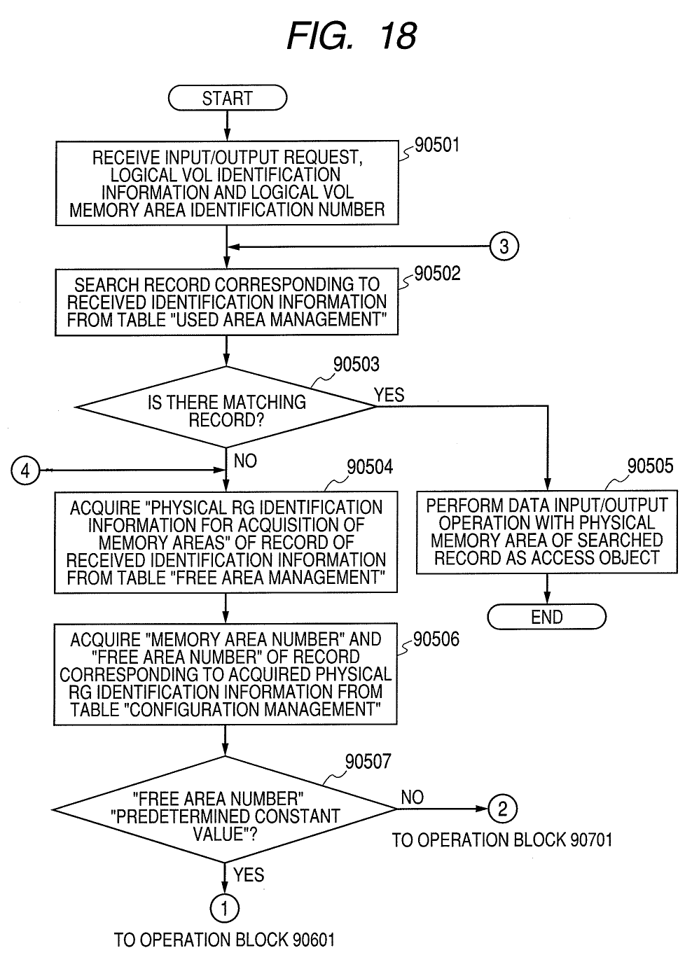

When the RAID controller 21000 receives an access 21401 to the extended DB area(C2) via the data path 41001, the input/output request processing program 21300 contained in the RAID controller 21000 is executed to make an access to the extended DB area (C2). This process will be described in more detail later with reference to FIG. 18.

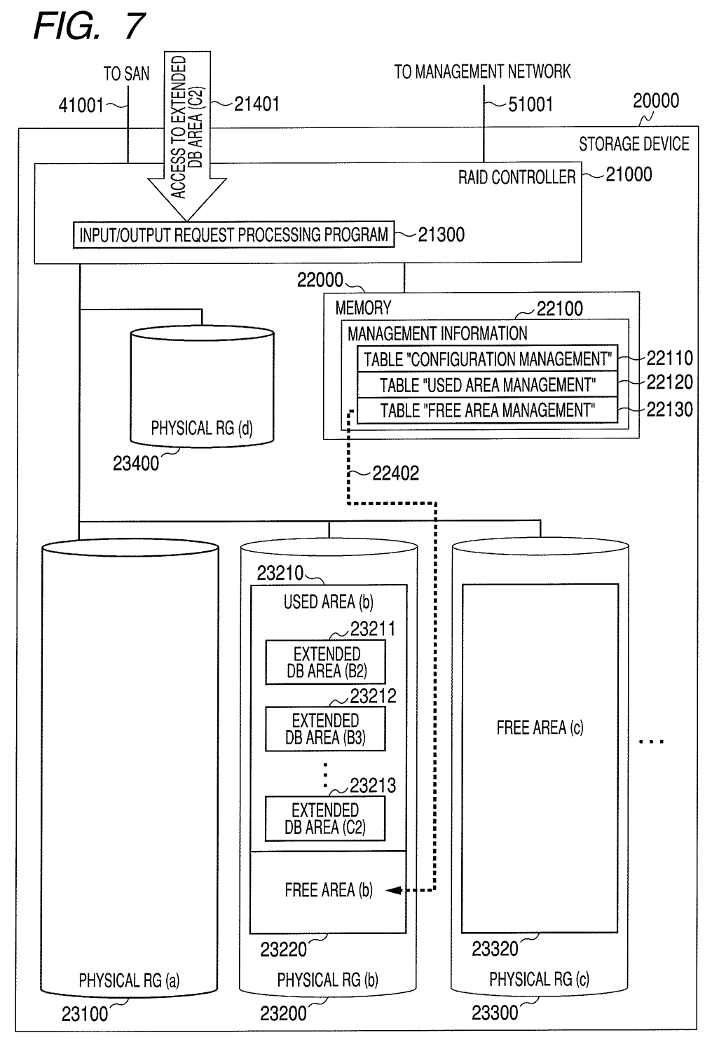

FIG. 7 shows a physical configuration of the storage device 20000 when the operation of FIG. 6 is performed. A memory area of a head of the free area(b) 23220 of physical RG (b) 23200 representing the table “free area management” 22130 as a memory area to be allocated next is allocated in a newly accessed extended DB area(C2) 23213. The table “free area management” 22130 is held as the extended DB area(C2) 23213 in the used area 23210 and is updated to indicate a head of the remaining free area(b) 23220.

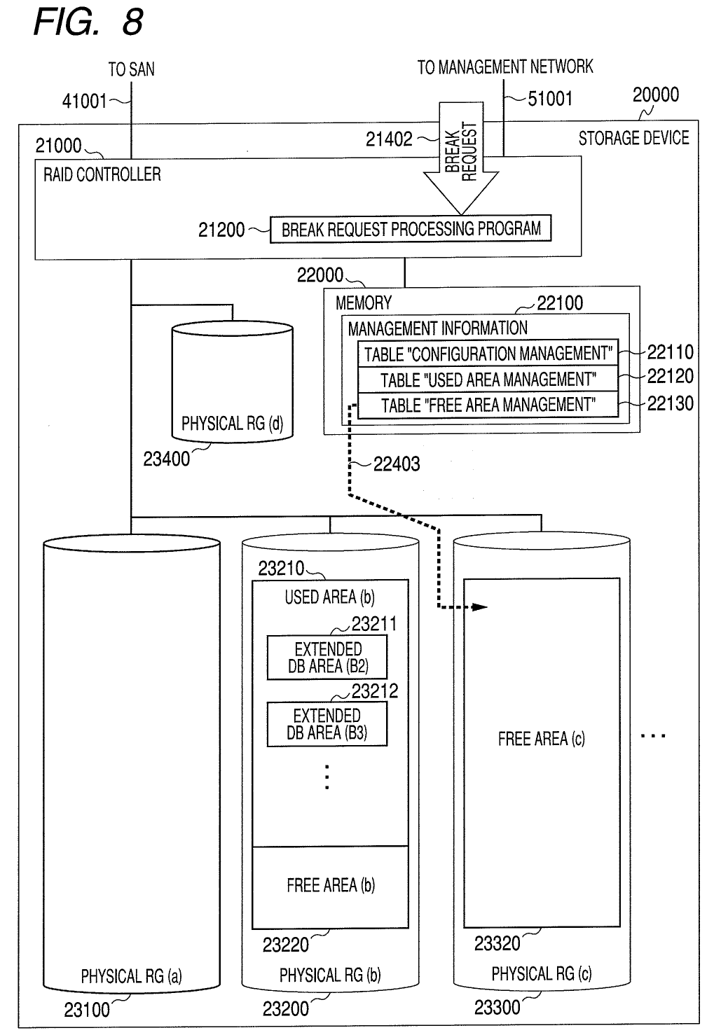

FIG. 8 shows a physical configuration of the storage device 20000 when the RAID controller 21000 receives a break request 21402 from the storage management server 30000 via the management network 50000.

Upon receiving the break request 21402, the RAID controller 21000 executes the internal break request processing program 21200. The break request processing program 21200 updates to point a head memory area of the free area(c) 23320 of the next physical RG(c) 23300 from a head memory area of the free area(b) 23220 of the physical RG(b) 23200 as a memory area of a physical RG which is being pointed by the table “free area management” and is allocated to a virtual volume next.

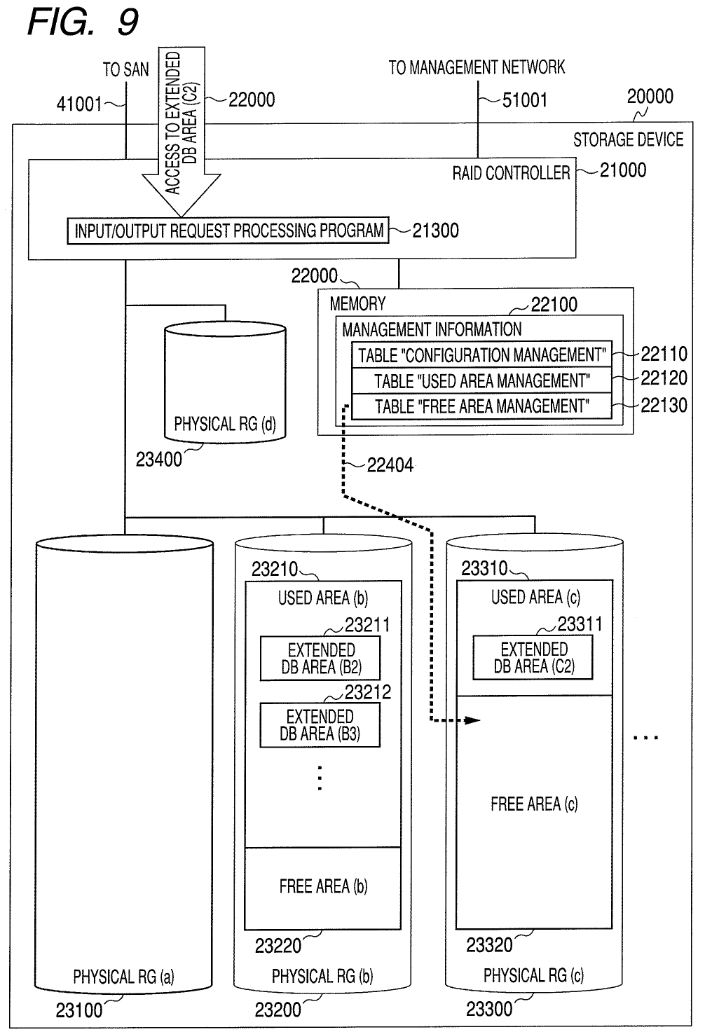

FIG. 9 shows a physical configuration of the storage device 20000 when there occurs an access 22000 to the extended DB area(C2) after the operation of FIG. 8.

Upon receiving the access 22000 to the extended DB area (C2) via the SAN 40000, the RAID controller 21000 executes the internal input/output request processing program 21300 to acquire a new memory area from a head memory area of the physical RG(C) 23300 represented by the table “free area management” 22130. An extended DB area(C2) 23311 of a used area 23310 is held as a memory area allocated to a virtual volume. The area represented by the table “empty area management” 22130 is updated as a head memory area of the free area 23320 except for an allocated area. In comparison with FIG. 7 having no receipt of break request, physical allocation of a memory area newly allocated to a virtual volume is varied depending on whether or not the storage device 20000 receives a break request.

The processes from FIG. 6 to FIG. 9 will be described in more detail later with reference to FIG. 18.

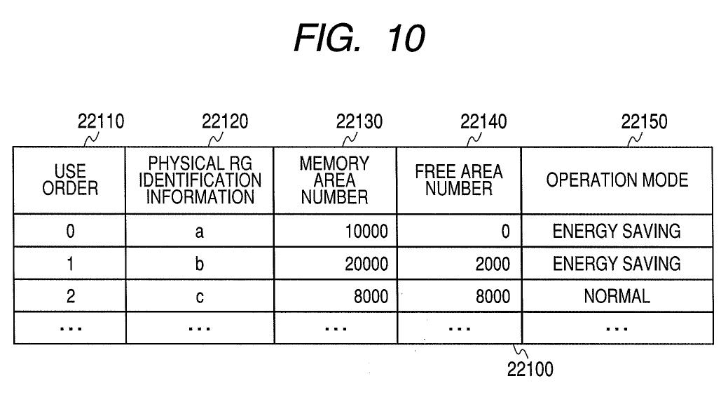

FIG. 10 shows a configuration of the table “configuration management” 22100. The table “configuration management” 22100 manages a list and order of a physical RG acquiring a memory area allocated to a virtual volume. Physical RG are registered as records with this table and are allocated to virtual volumes in a registered use order. The table “configuration management” 22100 includes a column “use order” 22110, a column “physical RG identification information” 22120, a column “memory area number” 22130, a column “free area number” 22140 and a column “operation mode” 22150.

In this embodiment, physical RGs registered in an ascending order are allocated to virtual volumes with values held in the column “use order” 22110. That is, according to an instructed order of allocation of a physical areas to virtual volumes, physical areas of the physical RG having a lower use order are first allocated to virtual volumes, and after completion of allocation of the physical areas of the physical RG to the virtual volumes, physical areas of the physical RG having a next lower use order are next allocated to the virtual volumes.

The column “physical RG identification information” 22120 may be a number or a symbol for identifying physical RGs handled by the storage device 20000.

The column “memory area number” 22130 may be a volume of memory blocks, such as the number of logical blocks or its integral multiples, which is a value corresponding to memory capacity of a physical RG.

The column “free area number” 22140 may be a volume, which is not allocated to a virtual VOL, of a volume of the memory blocks.

The column “operation mode” 22150 may be a value representing an operation mode of a physical RG. In this embodiment, as values of this column, “energy-saving” corresponds to a power-saving state and is intended to represent a spin down state with stop of the rotation of a disk, and “normal” corresponds to a state, which is responsible to an access from a host, and is intended to represent a spin up state. “Energy-saving” may include not only the spin down state but also a state of reduction of the number of rotations of a disk and a state of stop of supply of power to a disk.

A physical RG used to be allocated to a virtual volume before a break request is received may be set to be “energy-saving.” After the break request is received, if an access to a physical RG which is being used to be allocated to a virtual volume before the break request is received is reduced or completely vanished, power consumption can be reduced by setting the physical RG to be a power-saving state.

In addition, the virtual volume (d) (physical VOL (d)) is preferably is set to be a “normal” state since an access occurs uniformly or it is expected that an access will occur uniformly, irrespective of whether information is new or old.

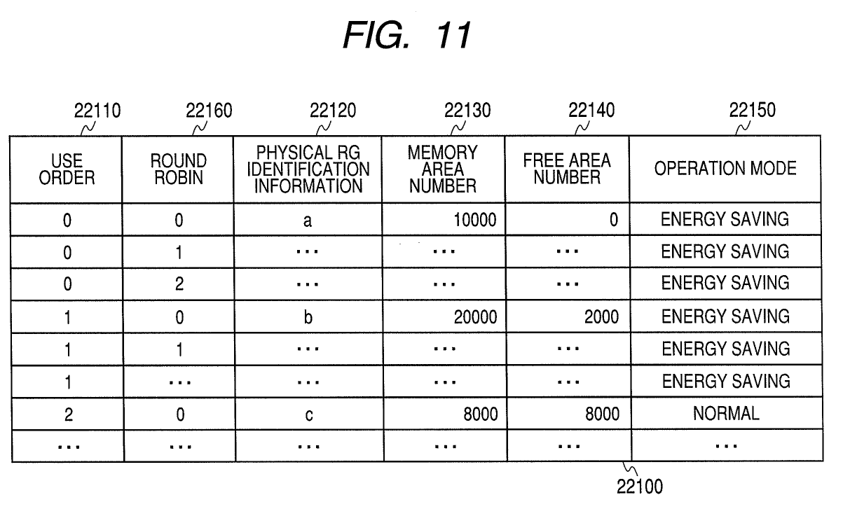

FIG. 11 shows another example of the table “configuration management” 22100. This is a configuration of a table “configuration definition” with which the configuration of FIG. 10 can be replaced. Also, this is an example of a configuration of a table when a plurality of physical RGs is grouped such that an access is not concentrated on a particular physical RG in allocating the physical RGs to virtual VOLs, and one physical RG is used as a round robin. That is, the table of FIG. 11 is a table configured by adding a column “round robin” 22160 to the table 22100 of FIG. 10. The column “round robin” 22160 allows a memory area to be allocated to a virtual VOL in preference of a round robin order to a use order. The present invention may be similarly applied even with such as allocation order. In this case, a physical RG group having the same value as a value of the column “use order” may be uses as a pool.

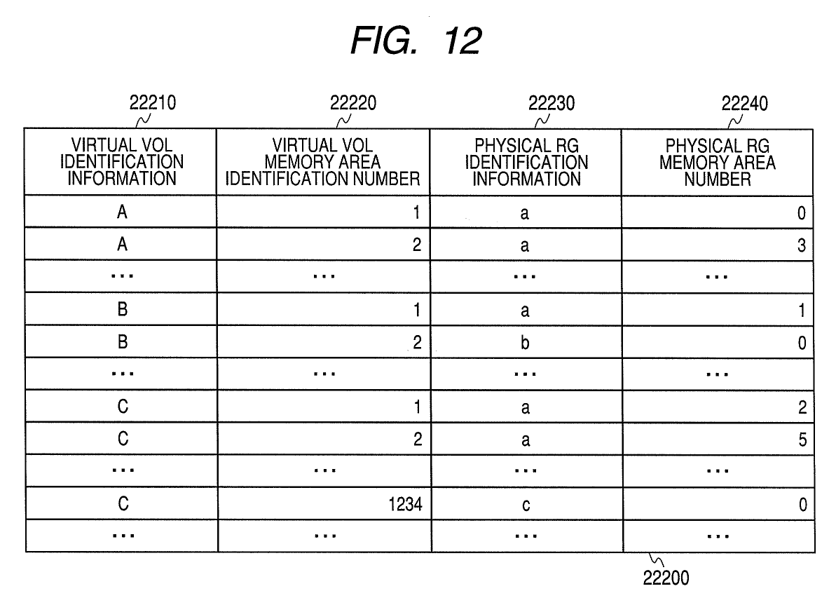

FIG. 12 shows a configuration of a table “used area management” 22200. The table “used area management” 22200 is a table mainly showing a corresponding relation between virtual memory areas provided to a host on a virtual VOL and memory areas actually storing data on a physical RG. The table “used area management” 22200 includes a column “virtual VOL identification information” 22210, a column “virtual VOL memory area identification number” 22220, a column “physical RG identification number” 22230 and a column “physical RG memory are a identification number” 22240. The column “virtual VOL identification information” 22210 stores a number or a symbol which identifies virtual volumes and is, for example, a logical unit number (LUN) of SCSI specification. The column “virtual VOL memory area identification number” 22220 and the column “physical RG memory area identification number” 22240 are, for example, logical block addresses (LBAS) in SCSI specification. The column “physical RG identification number” 22230 is the same as the column “physical RG identification number” 22120 shown in FIG. 11.

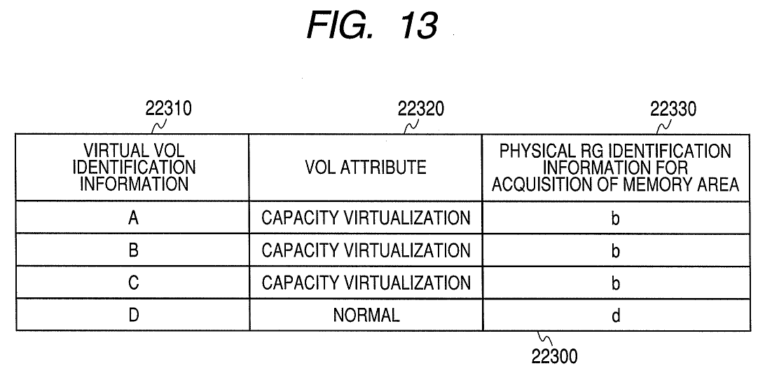

FIG. 13 shows a configuration of a table “free area management” 22300. The table “free area management” 22300 stores information indicating that a new memory area is acquired from which physical RG and VOL attribute information of each virtual volume. The table “free area management” 22300 includes a column “virtual VOL identification information” 22310, a column “VOL attribute” 22320 and a column “physical RG identification information for acquisition of memory area” 22330.

In this embodiment, the column “VOL attribute” 22320 stores information for distinguishing virtualization methods of its virtual volume. For example, as values of this column, “capacity virtualization” represents a virtualization method of sequentially allocating memory areas from a physical RG if the memory areas are needed according to an access to a virtual volume, and “normal” represents a virtualization method without allocating memory areas of a physical RG according to a virtualization access by all memory areas are always allocated from the physical RG in a one-to-one correspondence between a virtual volume and a physical RG without depending on an access or the like.

Specifically, in this embodiment, the virtual VOL (a) to the virtual VOL(c) become “capacity virtualization” and the virtual VOL(d) becomes “normal.”

The column “physical RG identification information for acquisition of memory area” 22330 represents a physical RG acquiring a newly required memory area. Also, this column represents a corresponding physical RG in a virtual volume to which capacity virtualization is not applied.

The column “VOL attribute” 22320 is not necessarily incorporated into the table 22300, but may be contained in a different table managing a volume.

Hereinafter, an operation of the RAID controller 20000 will be described with reference to relevant figures.

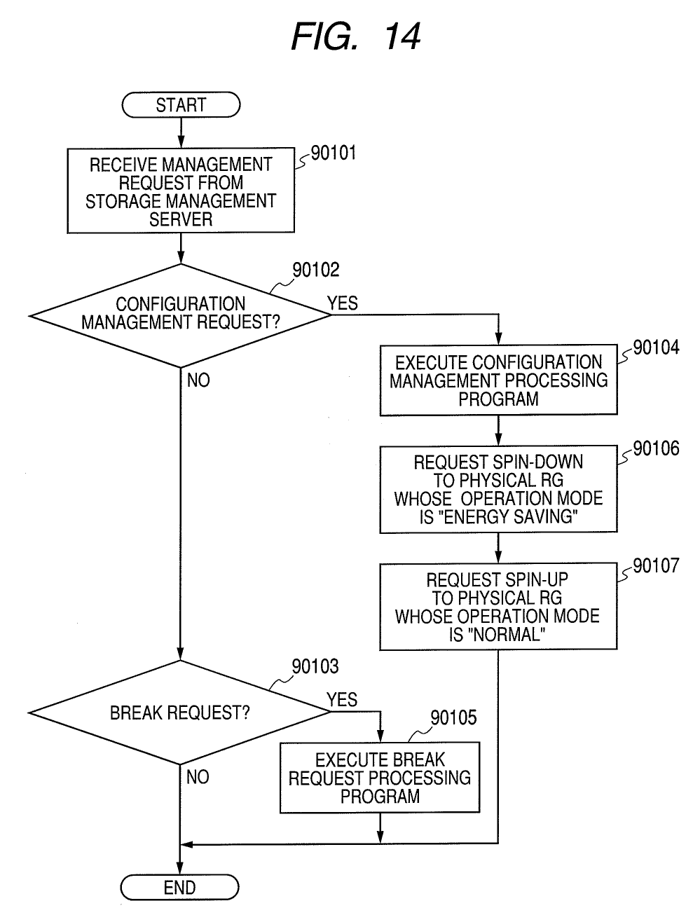

FIG. 14 shows an operation of the RAID controller 21000 when the RAID controller 21000 receives a management request via the management network 50000. The RAID controller 21000 receives a management request at operation block 90101 and performs operation block 90102.

If the received management request is a configuration management request at operation block 90102, the configuration management processing program 21100 is executed at operation block 90104. Specifically, at operation block 90106, a value of the column “physical RG identification information” 22120 of a record having a value of the column “operation mode” 22150 of the table “configuration management” 22100 as “power-saving” is acquired, and then a spin down request is sent to a physical RG corresponding to the acquired value. At operation block 90107, a value of the column “physical RG identification information” 22120 of a record having a value of the column “operation mode” 22150 of the table “configuration management” 22100 as “normal” is acquired, and then a spin up request is sent to a physical RG corresponding to the acquired value. Here, the spin down request and the spin up request correspond to commands “Start/Stop Unit” (1Bh) in SCSI standards, for example and are requests for control of rotation of a motor of a hard disk drive. When the rotation of the motor is stopped according to the spin down request, power consumption of the hard disk is generally reduced accordingly. The spin down request may not have to be immediately sent to the physical RG set to be “energy-saving,” and if there occurs no access to the physical RG within a limited period of time, the spin down request may be sent to the physical RG.

If the received management request is a break request at operation block 90103, the break request processing program 21200 is executed at operation block 90105. If the received management request is not a break request, the flow is ended.

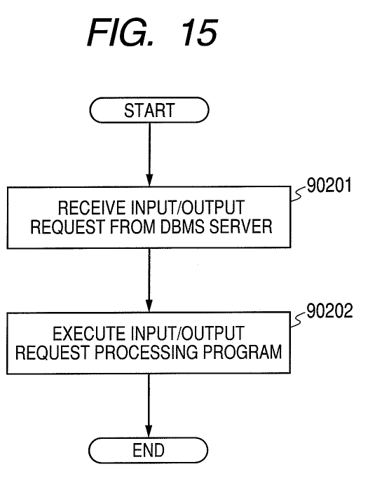

FIG. 15 shows an operation of the RAID controller 20000 when the RAID controller 20000 receives an input/output request via the SAN 40000. The RAID controller 20000 receives an input/output request from the DBMS server at operation block 90201 and executes and ends the input/output request program 21300 at operation block 90202.

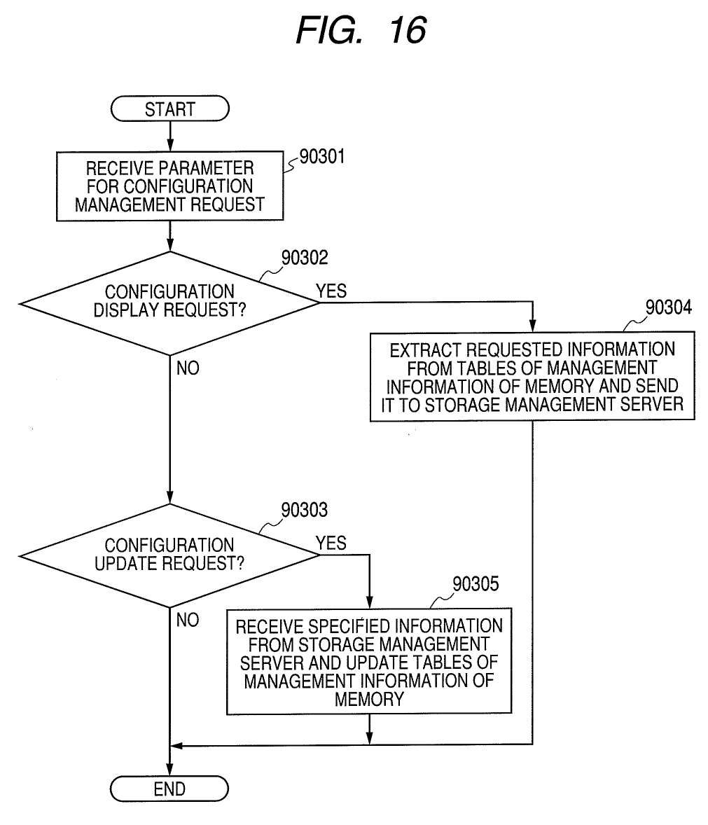

FIG. 16 shows an operation of the configuration management processing program 21100. A parameter for configuration management request is received at operation block 90301. Next, at operation block 90302, it is determined based on the received parameter whether the configuration management request is a configuration display request. If the configuration management request is a configuration display request, at operation block 90304, required information is extracted from the table “configuration management” 22110, the table “used area management” 22120 and the table “free area management” 22130, which are management information stored in a memory, and then is sent to the storage management server.

If the configuration management request is not a configuration display request at operation block 90302, at operation block 90303, it is determined based on the received parameter whether or the configuration management request is a configuration update request. If the configuration management request is a configuration update request, at operation block 90305, specified information is received from the storage management server 30000, and the table “configuration management” 22110, the table “used area management” 22120 and the table “free area management” 22130, which are management information tables stored in a memory, are updated.

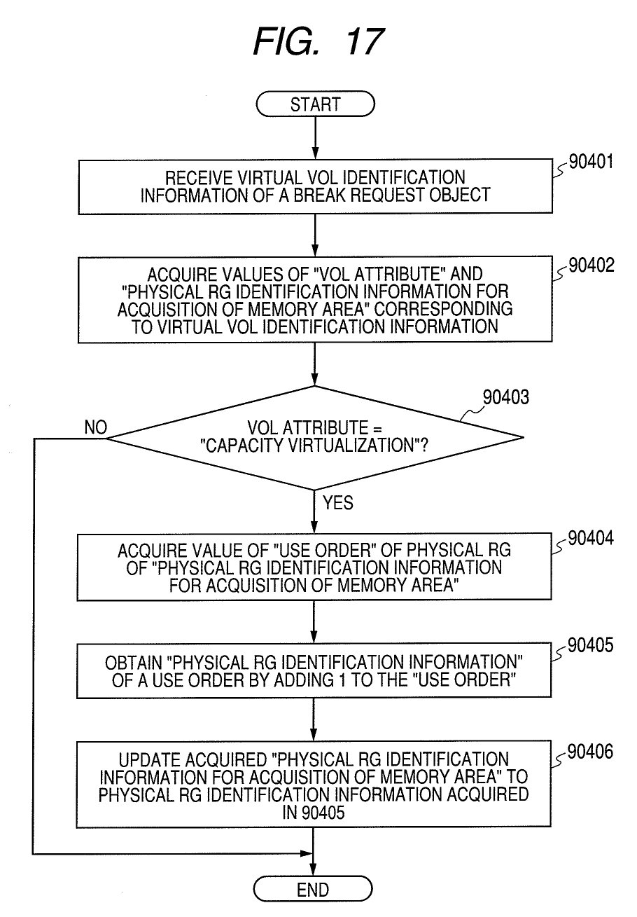

FIG. 17 shows an operation of the break request processing program 21200.

In this figure, the break request processing program 21200 starts when a break request is received from the storage management server 30000. This break request is automatically issued from the DBMS server or the management server. However, without being limited to this, the break request may be manually issued by manipulation of an operator. A timing at which the break request is issued is date and time after the deadline, such as the end of a month, the end of a term, the end of a year or the like, which is predetermined by a timer on the storage management server or the DBMS server. By issuing the break request for date and time after the deadline, such as the end of a month, the end of a term, the end of a year or the like, it is possible to store data having a low access frequency due to termination of a transaction and data having a high access frequency during a transaction in different physical RGs.

However, without being limited to this, a timing at which the break request is issued may be when a backup of volume data is started or ended. By issuing the break request at this timing, data can be dividedly stored in a physical RG storing backup data and a physical RG storing other data, thereby reducing performance interference without issuing a normal access and a backup access to the same physical RG.

In the operation of the break request processing program 21200, first, at operation block 90401, virtual VOL identification information, which is an object of the break request, is received from the storage management server 30000.

Thereafter, at operation block 90402, records having the received virtual VOL identification information are searched from the column “virtual VOL identification information” 22310 of the table “free area management” 22300 and values of the column “VOL attribute” 22320 and the column “physical RG identification information for acquisition of memory area” 22330 are acquired.

Next, at operation block 90403, it is determined whether or the acquired value of the column “VOL attribute” 22320 represents capacity virtualization. If this value represents capacity virtualization, the program proceeds to operation block 90404, and if this value does not represent capacity virtualization, the program is ended.

At operation block 90404, a record having the acquired physical RG identification information of the column “physical RG identification information for acquisition of memory area” is searched from the column “physical RG identification information” 22120 of the table “configuration management” 22100, and a value of the column “use order” 22110 of the record is acquired.

At operation block 90405, a record having a value obtained by adding 1 to a use order of a search result is searched from the column “use order” 22110 of the table “configuration management” 22100, and a value of the column “physical RG identification information” 22120 of the record is acquired.

At operation block 90406, the column “physical RG identification information for acquisition of memory area” 22330 of the record searched from the table “free area management” 22300 is updated as the physical RG identification information acquired in the previous operation block, and the program is ended.

According to the above-described break request process, when a physical volume is newly allocated to a virtual volume by the next input/output process, not a physical volume being currently used to be allocated to a virtual volume but a new physical volume having the lowest use order in a physical RG not being used (all memory areas are free areas) is allocated.

Accordingly, the latest newly allocated memory area can be allocated from a different physical RG after a certain time zone. If records stored in different virtual volumes are records created within a certain period of time (a period of time ranging from a previous division instruction to a current division instruction), the records can be collectively stored in at least one physical RG.

In this embodiment, in the operation of the break request processing program 21200, an operator may send a configuration management request from the storage management server 30000 and update the column “physical RG identification information for acquisition of memory areas” 22330 of the table “free area management” 22130 in the configuration management processing program 21100 shown in FIG. 16. In addition, if a memory area is to be acquired from a physical RG specified by the operator, the configuration management processing program 21100 may be used likewise.

Now, the operation of the input/output request processing program 21300 will be described with reference to FIGS. 18 to 20.

First, referring to FIG. 18, at operation block 90501, an input/output request, logical VOL identification information and a logical VOL memory area identification number are received.

Next, at operation block 90502, records in which the column “virtual VOL identification information” 22210 and the column “virtual VOL memory area identification number” 22220 of the table “used area management” 22200 match the received “logical VOL identification information” and “logical VOL memory area identification number,” respectively, are searched.

At operation block 90503, if it is determined based on a result of the search that there is a matching record, operation block 90505 is performed. If it is determined that there is no matching record, operation block 90504 is performed.

At operation block 90505, memory areas corresponding to values of the column “physical RG identification information” 22230 and the column “physical RG memory area identification number” 22240 of the matching record of the result of the search are accessed to perform a data input/output operation, and then the process is terminated.

If it is determined at operation block 90503 that there is no record to match the received identification number in the table “used area management” 22200, at operation block 90504, a record having the same logical VOL identification information of an object as a value of the column “virtual VOL identification information” 22310 of the table “free area management” 22300 is searched to acquire a value of the column “physical RG identification information for acquisition of memory areas” 22330 of the searched record.

Next, at operation block 90506, records in which the value of the RG identification information acquired in operation block 90504 matches a value of the column “physical RG identification information” 22120 of the table “configuration management” 22100 are searched to acquire values of the column “memory area number” 22130 and the column “free area number” 22140 of the searched records.

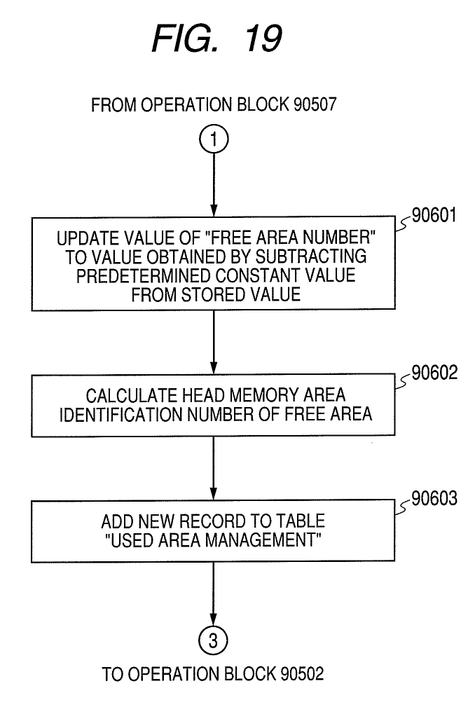

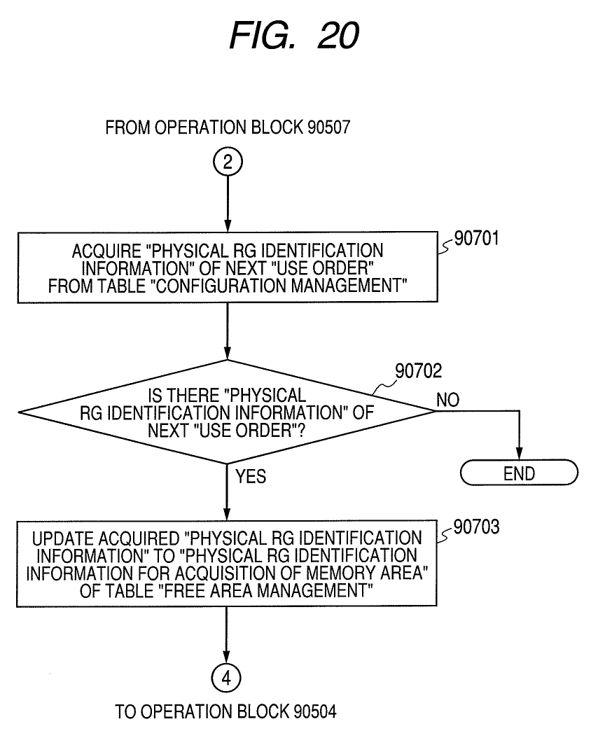

Then, at operation block 90507, it is determined whether or not the number of free areas acquired at operation block 90506 is more than a predetermined constant value. If so, operation block 90601 of FIG. 19 is performed, and otherwise, operation block 90701 of FIG. 20 is performed. Here, the predetermined constant value corresponds to the unit of allocation of a memory area and may be more than a value corresponding to one memory area.

Referring to FIG. 19, operation block 90601, the value of the column “free area number” of the record searched at operation block 90506 is updated to a value obtained by subtracting a predetermined constant value from a stored value.

At operation block 90602, a head memory area identification number of an free area is calculated from values of the column “memory area number” and the column “free area number” acquired at operation block 90506. Here, for example, a value obtained by subtracting the value of the column “free area number” from the value of the column “memory area number” may be used for this calculation.

At operation block 60603, virtual VOL identification information of an input/output object, a virtual VOL memory area identification number, the physical RG identification information of the searched free area and the head memory area identification number of the calculated free area are configured and added as a record of the table “used area management” 22200. Thereafter, operation block 90502 of FIG. 18 is performed.

Referring to FIG. 20, operation block 90701, a record in which a value obtained by adding 1 to the value of the column “use order” 22110 of the table “configuration management” 22100 acquired at operation block 90506, which corresponds to the record searched at operation block 90506, matches the value of the column “use order” 22110 of the table “configuration management” 22100 is searched to acquire a value of the column “physical RG identification information” 22120 of the searched record. That is, physical RG identification information in a next use order is obtained.

At operation block 90702, it is determined whether or not there is a matching record in the search of operation block 90701 (that is, whether or not a physical RG of the next use order exists). If so, operation block 90703 is performed, and otherwise, the program is ended.

At operation block 90703, the value of the column “physical RG identification information for acquisition of memory areas” of the searched record of the table “free area management” is updated to a value of the column “physical RG identification information” of the searched record of operation block 90701, and then operation block 90504 of FIG. 18 is performed. At this time, if there exists a record having the same value in the column “physical RG identification information for acquisition of memory areas” of the table “free area management” 22300, the update may be achieved likewise.

Hitherto, the operations of the configuration management processing program 21100, the break request processing program 21200 and the input/output request processing program 21300 contained in the RAID controller 20000 have been described.

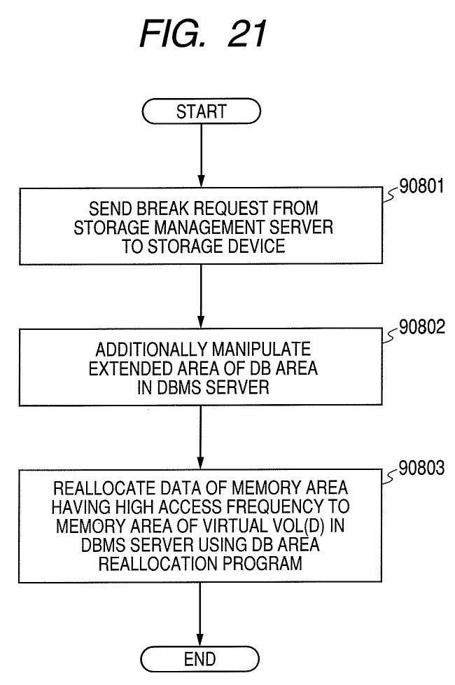

FIG. 21 shows a sequence of division instructions performed in the storage management server 30000 by an operator.

At operation block 90801, a break request is sent from the storage management server 30000 to a storage device.

At operation block 90802, an extended area of a DB area is additionally manipulated using the DBMS program 12200 from the DB server 10000.

At operation block 90803, the DBMS server 10000 reallocates data of a memory area having a high access frequency to a memory area of the virtual VOL (D) 24400 using the DB area reallocation program 12100.

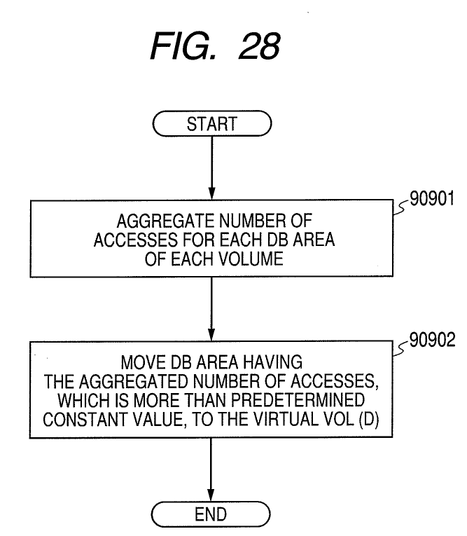

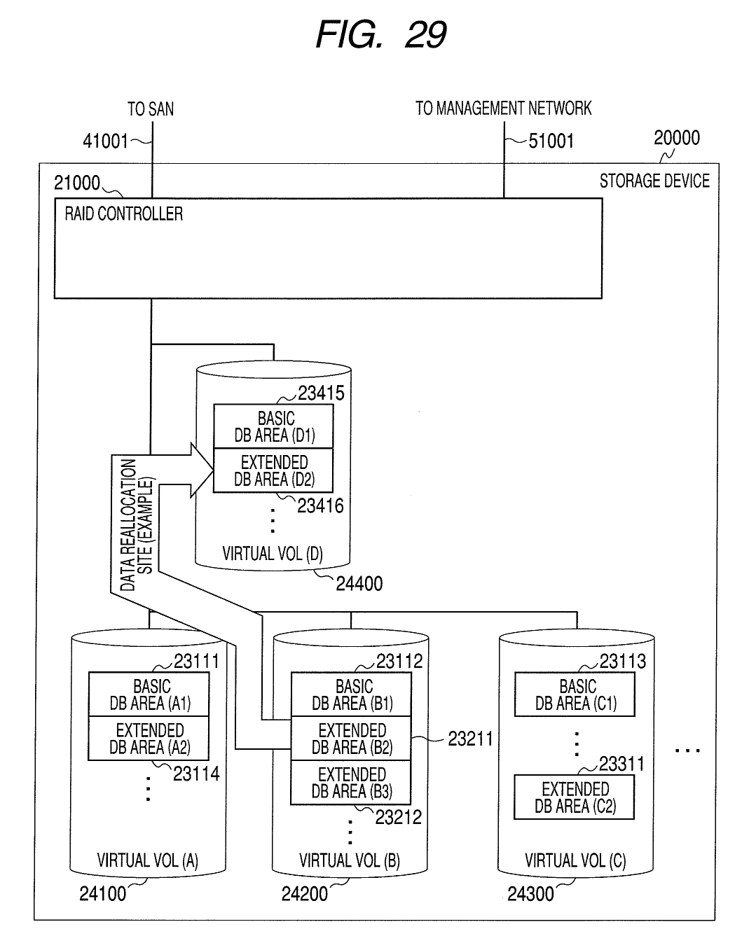

Now, an operation of the DB area reallocation program 12100 will be described with reference to FIGS. 28 and 29. Referring to FIG. 28, at operation block 90901, a volume access from the DBMS program 12200 is monitored and the number of accesses for each DB area of each volume is totaled. Next, at operation block 90902, a DB area having the number of accesses after the last break request performance, which is the number of accesses totaled at operation block 90901 for a DB area existing before the last break request performance and is more than a predetermined constant value, is moved to the virtual VOL (D) 24400. For the purpose of reduction of power consumption, the predetermined constant value may be “1” since an access of data to a spun-down physical RG may cause performance deterioration. However, not for power saving, but for the purpose of reduction of performance interference with backup or the like, the predetermined constant value may be more than 1 set by a designer or a manager. FIG. 29 shows an example of reallocation when the number of accesses exceeds a prescribed value. In this example, a DB area 23211 of the virtual VOL (D) 24200 is reallocated as an extended DB area (D2) 23416 to the virtual VOL (D) 24400. Although DB area management information, virtual VOL management information and the like are stored in the virtual VOL(D), the extended DB area (D2) is created to store data of the DB area 23211 newly. As an example of reallocation process, data may be copied to a DB area having the same capacity secured in a reallocation site and the data of the original DB area 23211 may be deleted. If the existing DB area 23415 of the virtual VOL (D) 24400 is empty by more than data capacity stored in the DB area 23211, data may be additionally stored in the DB area 23415. In addition, the DB area reallocation program 12100 may take not only an access statistics of the unit of DB area but also an access statistics of the smaller unit such as the unit of data block of a volume, for example. Even in this case, DB areas may be reallocated in the same way.

As can be seen from the above description, particularly, for example, in an ERP system having greatly different access frequencies before and after an account deadline such as the end of a term or the end of a year, a break request is issued after termination of an account closing process. In addition, by changing an operation mode of a physical RG used before break request performance to “energy-saving,” it is possible to reduce power consumption of the physical RG.

When there occurs an access to the physical RG, the physical RG changed to “energy-saving” may be controlled to be changed to a “normal” operation mode. In addition, this physical RG may be again changed to the operation mode of “energy-saving” after a certain period of time elapses from the last access.

In addition, an access schedule such as an access to the physical RG changed to “energy-saving,” which is concentrated within a certain period of time is set, and then the physical RG may be controlled to be changed to the “normal” operation mode according to the set access schedule.

In addition, in case of no application of the present invention, for example, in case where no division instruction is issued to the storage device 20000, since new and old records are mixed in the same physical RG, an enormous amount of data is required to reallocate data at operation block 90803. That is, the present invention has an effect of greatly reducing the amount of data required for reallocation.

In addition, when a record is backed up before a division instruction, since a stored physical RG is different from a record after the division instruction, a physical RG accessed for backup is different from a physical RG accessed for transaction to a new record after the division instruction. Accordingly, even when the backup and the transaction coincide, it is possible to prevent process performance from being deteriorated.

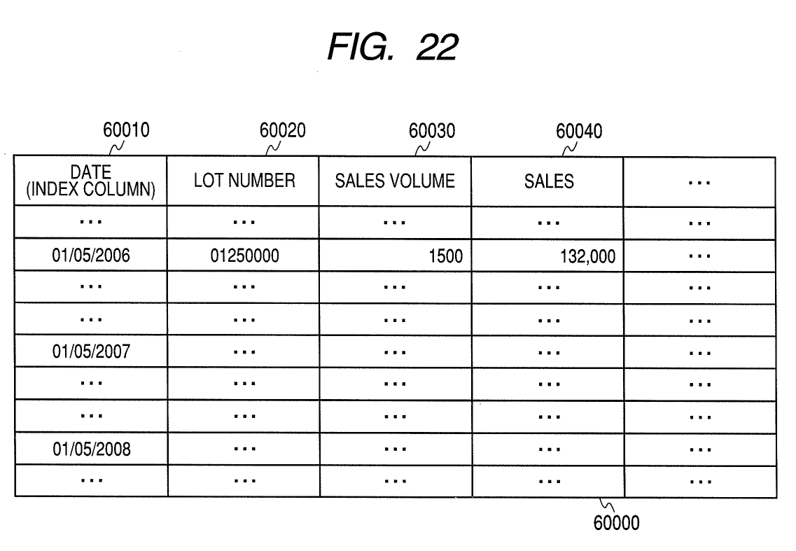

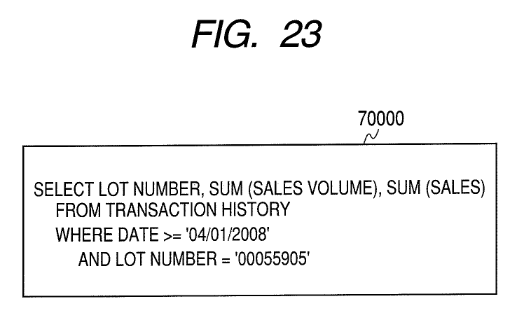

FIGS. 22 and 23 show a DB table configuration exhibiting a remarkable effect of the present invention, and an example of SQL inquiry to the DB table, respectively.

FIG. 22 shows a DB table “transaction history” 60000. The DB table “transaction history” 60000 is an example of a table with which transaction contents are registered as a record in an ERP system.

The DB table “transaction history” 60000 includes, for example, a column “date” 60010, a column “lot number” 60020, a column “sales volume” 60030 and a column “sales” 60040. Here, the column “date” 60010 is defined as an INDEX column.

FIG. 23 shows an example of SQL inquiry to the DB table “transaction history” 60000 of FIG. 22. When a term such as a year or the like is included in search conditions, it is possible to reduce an access to a record other than the term. This inquiry means a SQL inquiry to obtain the total of each of sales volume and sales of a product having a lot number of “00055905” from Apr. 1, 2008.

### (2) Embodiment 2

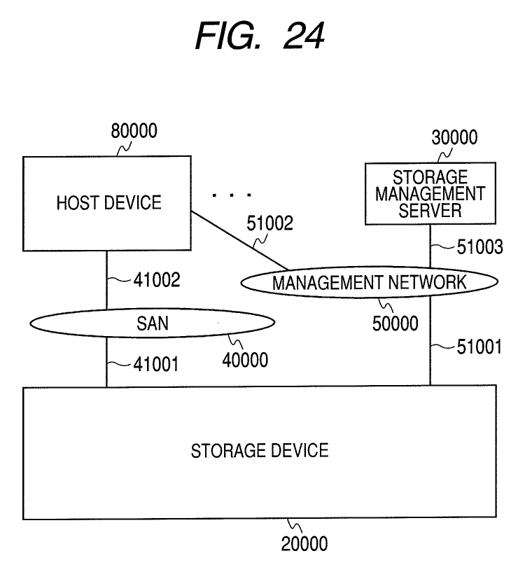

Embodiment 2 of the present invention is an IT system in which FIGS. 1 to 4 are replaced with FIGS. 24 to 27, respectively.

Accordingly, Embodiment 2 has a configuration where the DBMS server 10000 of FIG. 1 is replaced with a host device 80000.

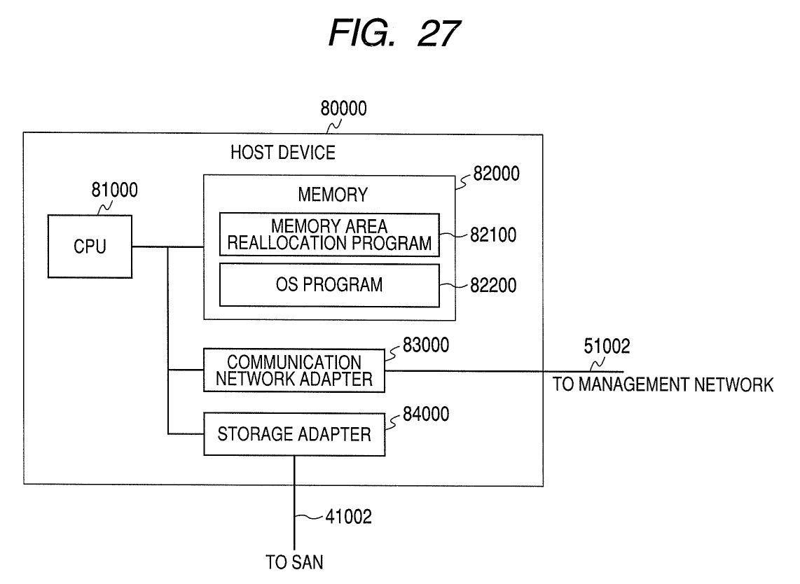

A configuration of the host device is shown in FIG. 27. Here, a memory area reallocation program 82100 plays the same role as the DB area reallocation program 12100. An OS program 82200 plays the same role as the DBMS program 12200. In particular, an area of a file system implemented on the OS program corresponds to a DB area consisting of a basic DB area and an extended DB area.

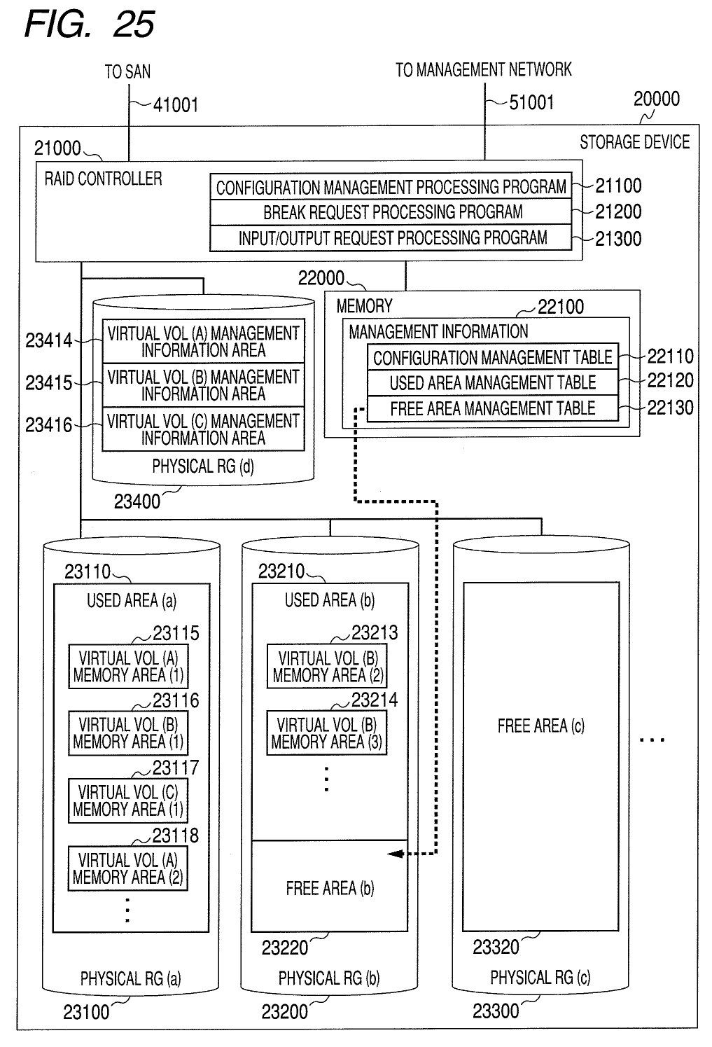

FIG. 25 is different from FIG. 2 in that DB areas in FIG. 25 are taken as the memory areas in FIG. 2. For example, the basic DB area (A1) 23111 corresponds to a virtual VOL (A) memory area(1) 23115. Likewise, the basic DB area(B1) 23112 corresponds to a virtual VOL (B) memory area(1) 23116, the basic DB area(C1) 23113 corresponds to a virtual VOL(C) memory area(l) 23117, the extended DB area(A2) 23114 corresponds to a virtual VOL(A) memory area(2) 23118, the extended DB area(B2) 23211 corresponds to a virtual VOL(B) memory area(2) 23213, the extended DB area (B3) 23212 corresponds to a virtual VOL (B) memory area(3) 23214, the DB area management area (A0) 23411 corresponds to a virtual VOL(A) management information area 23414, the DB area management area(B0) 23411 corresponds to a virtual VOL(B) management information area 23414, and the DB area management area(C0) 23411 corresponds to a virtual VOL(C) management information area 23414.

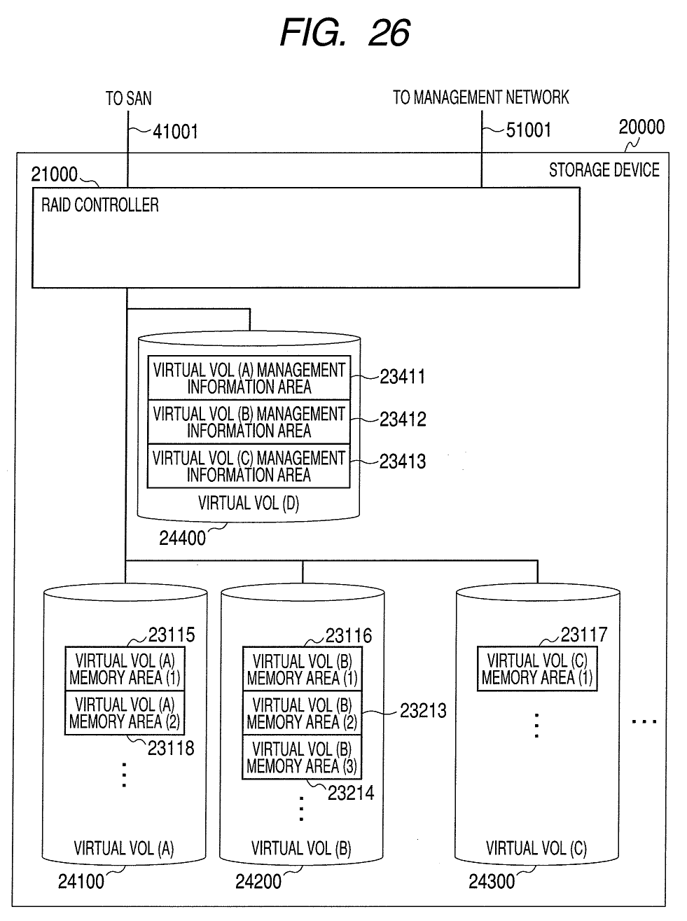

FIG. 26 shows a logical configuration of the storage device 20000. FIG. 26 has a correspondence relation with FIG. 3 in the same way as FIG. 25.

Similarly, other components of the present invention can be practiced with no limitation.

With the above configuration, in file storage for archive written-once with lapse of time, a storing site of a physical RG of data of an old file before a division instruction is different from a storing site of a physical RG of data of a new file after the division instruction. Accordingly, the physical RG in which the old file before the division instruction is stored can be power-saved such as spin down or the like.

In addition, when a data reallocation program is applied by performance of a break request, the amount of reallocated data can be reduced.

In addition, when a file is backed up before a division instruction, since a stored physical RG is different from a file after the division instruction, a physical RG accessed for backup is different from a physical RG accessed for transaction to a new record after the division instruction. Accordingly, even when the backup and the transaction coincide, it is possible to prevent process performance from being deteriorated.

What is claimed is:

1. A storage device comprising:
a memory unit which constitutes a plurality of physical RAID groups including a plurality of first physical RAID groups; and
a controller,
wherein the controller:
allocates a memory area of a plurality of the first physical RAID groups to a first virtual volume based on a use order of a plurality of the first physical RAID groups according to an access to the first virtual volume,
receives a break request, and
allocates the memory area of a physical RAID group included in a plurality of the first physical RAID groups of the next use order to the first virtual volume according to the access to the first virtual volume after receiving the break request.

2. The storage device according to claim 1, wherein the controller transitions the memory unit including the first physical RAID group having the memory area allocated to the first virtual volume before receiving the break request to a power-saving state after receiving the break request.

3. The storage device according to claim 2, wherein, when there is an access to the first physical RAID group transitioned to the power-saving state, the memory unit is transitioned from the power-saving state to a state that is responsible to the access.

4. The storage device according to claim 2, wherein a schedule of an access to the first physical RAID group transitioned to the power-saving state is set, and the memory unit is transitioned from the power-saving state to a state that is responsible to the access, according to the set access schedule.

5. The storage device according to claim 1, wherein the plurality of physical RAID group includes a second physical RAID group, and a memory area of the second physical RAID group is allocated to a second virtual volume without depending on an access.

6. The storage device according to claim 5, wherein the memory unit including the second physical RAID group is in a state which is responsible to an access.

7. The storage device according to claim 6, wherein the controller moves the data to the second physical RAID group when the number of accesses, after receiving the break request, to data stored in the first physical RAID group having the memory area allocated to the first virtual volume before receiving the break request exceeds a prescribed value.

8. A method of allocating a memory area to a virtual volume of a storage device including a memory unit including a plurality of physical RAID groups including a first physical RAID group, and a controller, the method comprising the steps of:
sequentially allocating a memory area of the first physical RAID group or a pool memory area including a plurality of first physical RAID groups to a first virtual volume based on a use order according to an access to the first virtual volume;
receiving a break request; and
allocating the memory area of the first physical RAID group of the next use order or the pool memory area including the plurality of first physical RAID groups of the next use order to the first virtual volume according to the access to the first virtual volume after receiving the break request.

9. The method according to claim 8, further comprising the step of transitioning the memory unit including the first physical RAID group having the memory area allocated to the first virtual volume before receiving the break request to a power-saving state after receiving the break request.

10. The method according to claim 9, wherein, when there is an access to the first physical RAID group transitioned to the power-saving state, the memory unit is transitioned from the power-saving state to a state that is responsible to the access.

11. The method according to claim 9, wherein a schedule of an access to the first physical RAID group transitioned to the power-saving state is set, and the memory unit is transitioned from the power-saving state to a state that is responsible to the access, according to the set access schedule.

12. The method according to claim 8, wherein the plurality of physical RAID group includes a second physical RAID group, and a memory area of the second physical RAID group is allocated to a second virtual volume without depending on an access.

13. The method according to claim 12, wherein the memory unit including the second physical RAID group is set to be a state which is responsible to an access.

14. The method according to claim 13, further comprising the step of moving the data to the second physical RAID group when the number of accesses, after receiving the break request, to data stored in the first physical RAID group having the memory area allocated to the first virtual volume before receiving the break request exceeds a prescribed value.

15. A storage device comprising:
a memory unit including a plurality of physical RAID groups including a first physical RAID group and a second physical RAID group; and
a controller,
wherein the controller sequentially allocates a memory area of the first physical RAID group or a pool memory area including a plurality of first physical RAID groups to a first virtual volume based on a use order according to an access to the first virtual volume,
wherein a memory area of the second physical RAID group is in a state which is always responsible to an access, and is allocated to a second virtual volume without depending on an access,
wherein the controller:
receives a break request,
allocates the memory area of the first physical RAID group of the next use order or the pool memory area including the plurality of first physical RAID groups of the next use order to the first virtual volume according to the access to the first virtual volume after receiving the break request,
transitions the memory unit including the first physical RAID group having the memory area allocated to the first virtual volume before receiving the break request to a power-saving state after receiving the break request, and
moves the data to the second physical RAID group when the number of accesses, after receiving the break request, to data stored in the first physical RAID group having the memory area allocated to the first virtual volume before receiving the break request exceeds a prescribed value.
